(19) United States
(12) Patent Application Publication
(10) Pub. No.: US 2018/0249025 A1
(43) Pub. Date: Aug. 30, 2018

(54) INFORMATION PROCESSING EQUIPMENT

(71) Applicant: Konica Minolta, Inc., Chiyoda-ku Tokyo (JP)

(72) Inventors: Yusuke NAKAYAMA, Toyokawa-shi Aichi-ken (JP); Hideyuki NUKUMI, Ama-gun Aichi-ken (JP)

(21) Appl. No.: 15/902,411

(22) Filed: Feb. 22, 2018

(30) Foreign Application Priority Data
Feb. 24, 2017 (JP) 2017-033013

(51) Int. Cl. H04N 1/00; G03G 15/20

(52) U.S. Cl. CPC H04N 1/00244; H04N 1/00209; H04N 1/00167; G03G 15/2053

(57) ABSTRACT

Information processing equipment includes an image forming apparatus which has a first outer surface and a server apparatus which has a second outer surface opposed to the first outer surface at a distance therefrom, the server apparatus being connected to a network and performing predetermined processing. The information processing equipment has a coupling portion which integrates the image forming apparatus and the server apparatus with each other by coupling a first coupling region located on the first outer surface and a second coupling region located on the second outer surface to each other and an air passage space portion through which outside air can pass, the air passage space portion being provided between a first opposing region on the first outer surface other than the first coupling region and a second opposing region on the second outer surface other than the second coupling region.

### CROSS REFERENCE TO RELATED APPLICATION

The present application claims priority under 35 U.S.C. § 119 to Japanese Application No. 2017-033013 filed Feb. 24, 2017, the entire content of which is incorporated herein by reference.

### BACKGROUND

### Technological Field

The present invention relates to information processing equipment including a server apparatus and an image forming apparatus which are integrated with each other.

### Description of the Related Art

A heater is often provided in the vicinity of a paper carrying portion or an image carrier in an image forming apparatus. By applying heat to the paper carrying portion, failure in transportation due to a humidified state of paper can be suppressed. By applying heat to the image carrier, generation of a poor printed image due to a humidified state of the image carrier can be suppressed.

The image forming apparatus may also be provided with an air duct therein together with the heater as above in some cases. Each functional portion is cooled or heat is exhausted to the outside of the apparatus through the air duct. For example, influence on other functional portions due to increase in temperature of each functional portion in the apparatus such as solidification of toner can be suppressed (Japanese Laid-Open Patent Publications Nos. 2001-166650 and 11-338333).

In an environment for working such as an office in recent years, an image forming apparatus is used for printing data created with a computer on recording paper and a server apparatus is generally used for various purposes such as storage, organization, or processing of data created with a computer.

The server apparatus is connected to a client apparatus through a network and performs processing based on a predetermined computer program in response to a request from the client apparatus. The server apparatus can function, for example, as a mail server, a web server, an application server, a file server, or a printer server.

In general, the server apparatus is always on and heat is steadily exhausted therefrom by being equipped with a fan or the like in order to suppress lowering in operational processing capability or reduction in longevity of electronic components due to heat generation.

### SUMMARY

The image forming apparatus and the server apparatus have conventionally been installed at different locations at a distance from each other. When the image forming apparatus and the server apparatus are integrated with each other, a plurality of functions as above can be achieved by one piece of information processing equipment, and various improvements, for example, from a point of view of reduction in cost, energy saving, and space saving can be contemplated.

Information processing equipment in which the image forming apparatus and the server apparatus are integrated with each other is required to suppress conduction of heat generated in the image forming apparatus to the server apparatus or conduction of heat generated in the server apparatus to the image forming apparatus regardless of a state of operation and to efficiently exhaust heat to the outside of the information processing equipment.

Both of Japanese Laid Open Patent Publications Nos. 2001-166650 and 11-338333 are directed to inventions for suppression of increase in temperature in the image forming apparatus or improvement in heat radiation characteristics in the inside of the image forming apparatus. Japanese Laid Open Patent Publications Nos. 2001-166650 and 11-338333, however, are silent about the concept of suppression of increase in temperature or improvement in heat radiation characteristics in information processing equipment constructed such that the image forming apparatus and the server apparatus are integrated with each other.

The present invention was made in view of the circumstances as described above, and an object of the present invention is to provide information processing equipment including a server apparatus and an image forming apparatus integrated with each other which is capable of achieving suppressed conduction of heat generated in the image forming apparatus to the server apparatus or suppressed conduction of heat generated in the server apparatus to the image forming apparatus and efficiently exhausting the heat to the outside of the information processing equipment.

In order to achieve at least one of the abovementioned objects, according to an aspect of the present invention, information processing equipment reflecting one aspect of the present invention comprises an image forming apparatus which has a first outer surface, the image forming apparatus forming an image on a recording medium, and a server apparatus which has a second outer surface opposed to the first outer surface at a distance from the first outer surface, the server apparatus being connected to a network and performing predetermined processing. The information processing equipment has a coupling portion which integrates the image forming apparatus and the server apparatus with each other by coupling a first coupling region located on the first outer surface of the image forming apparatus and a second coupling region located on the second outer surface of the server apparatus to each other and an air passage space portion through which outside air can pass, the air passage space portion being provided between a first opposing region on the first outer surface other than the first coupling region and a second opposing region on the second outer surface other than the second coupling region.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a perspective view showing an external construction of information processing equipment 101 in a first embodiment.

FIG. 2 is a cross-sectional view schematically showing an internal construction of information processing equipment 101 in the first embodiment when viewed from the front.

FIG. 3 is a front view showing a server apparatus 20 and a coupling portion 30 included in information processing equipment 101 in the first embodiment, and shows information processing equipment 101 in FIG. 1 from which covers 21 and 22 have been removed in a direction shown with an arrow III in FIG. 1.

FIG. 4 is a cross-sectional view along the line IV-IV in FIG. 3.

FIG. 5 is a perspective view showing server apparatus 20 and coupling portion 30 included in information processing equipment 101 in the first embodiment.

FIG. 6 is a cross-sectional view schematically showing server apparatus 20 and coupling portion 30 included in information processing equipment 102 in a second embodiment when viewed from the front.

FIG. 7 is a cross-sectional view schematically showing server apparatus 20 and coupling portion 30 included in information processing equipment 103 in a third embodiment when viewed from the front.

FIG. 8 is a cross-sectional view schematically showing server apparatus 20 and coupling portion 30 included in information processing equipment 104 in a fourth embodiment when viewed from the front.

### DETAILED DESCRIPTION OF EMBODIMENTS

Hereinafter, one or more embodiments of the present invention will be described with reference to the drawings. However, the scope of the invention is not limited to the disclosed embodiments.

### First Embodiment

(Information Processing Equipment 101)

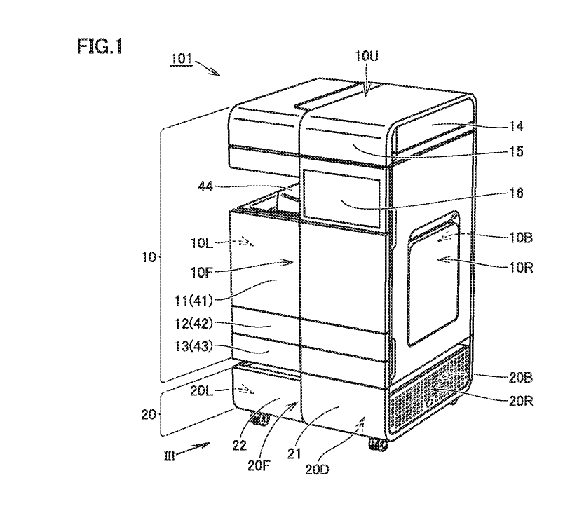

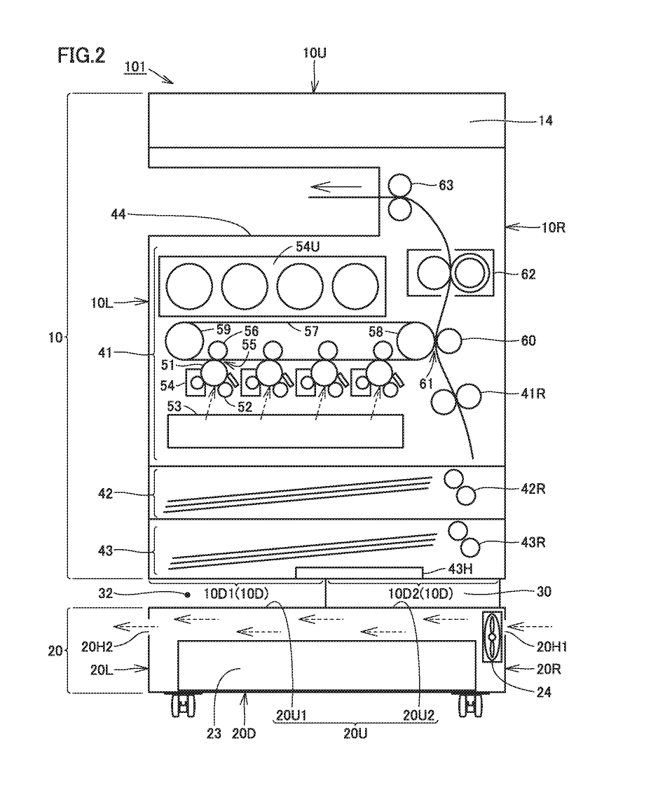

FIG. 1 is a perspective view showing an external construction of information processing equipment 101 in a first embodiment. FIG. 2 is a cross-sectional view schematically showing an internal construction of information processing equipment 101 in the first embodiment when viewed from the front. As shown in FIG. 1 and FIG. 2, information processing equipment 101 includes an image forming apparatus 10, a server apparatus 20, and a coupling portion 30 (FIG. 2) provided between image forming apparatus 10 and server apparatus 20.

(Image Forming Apparatus 10)

As shown in FIG. 1, an outer geometry of image forming apparatus 10 is substantially in a form of a parallelepiped as a whole, and image forming apparatus 10 has a front surface 10F, a back surface 10B, a right side surface 10R, a left side surface 10L, an upper surface 10U, and a first outer surface 10D (FIG. 2). First outer surface 10D is an outer surface of a housing of image forming apparatus 10 opposed to server apparatus 20 and it corresponds to a bottom surface of image forming apparatus 10 in the present embodiment.

Image forming apparatus 10 (FIG. 2) includes as its constituent elements, an image forming portion 41 which forms an image on a recording medium (typically recording paper) and paper carrying portions 42 and 43, all of which are arranged inside image forming apparatus 10. Image forming portion 41 includes a photoconductor 51, a charging apparatus 52, an exposure apparatus 53, a development apparatus 54, a toner unit 54U, a primary transfer portion 55, a primary transfer roller 56, an intermediate transfer belt 57, support rollers 58 and 59, a secondary transfer roller 60, a secondary transfer portion 61, a fixing portion 62, and a paper ejection roller 63.

Four sets of photoconductor 51 and primary transfer portion 55 are provided in correspondence with yellow, magenta, cyan, and black colors, and image forming apparatus 10 forms toner images corresponding to respective colors on a surface of intermediate transfer belt 57 by using such equipment. Toner images of respective colors are layered on one another on the surface of intermediate transfer belt 57 and thereafter intermediate transfer belt 57 transports the color toner image to secondary transfer portion 61 between intermediate transfer belt 57 and secondary transfer roller 60.

Paper carrying portions 42 and 43 are provided in a lower portion of image forming apparatus 10 and accommodates a plurality of sheets of recording paper. As shown in FIG. 2, a heater 43H for dehumidifying recording paper may be provided inside paper carrying portion 43. By applying heat to paper carrying portion 43 or 42, failure in transportation due to a humidified state of paper can be suppressed and hence image quality can be improved.

Pick-up rollers 42R and 43R and a timing roller 41R form a part of a paper transportation path and recording paper is transported to secondary transfer portion 61 through pick-up rollers 42R and 43R and timing roller 41R. The color toner image carried on intermediate transfer belt 57 is transferred to a surface of recording paper in secondary transfer portion 61. The color toner image is fixed onto the surface of recording paper by fixing portion 62. The recording paper is thereafter ejected to a paper ejection portion 44 by paper ejection roller 63.

Referring again to FIG. 1, an operation panel 16, a cover 11 which covers image forming portion 41, a cover 12 which covers paper carrying portion 42, and a cover 13 which covers paper carrying portion 43 are provided on a side of front surface 10F of image forming apparatus 10. Cover 11 is opened in maintenance and inspection of image forming portion 41 (FIG. 2) or replacement of toner unit 54U (FIG. 2). When paper is added, cover 12 is pulled forward together with paper carrying portion 42 (which is also called a paper feed cassette) or cover 13 is pulled forward together with paper carrying portion 43.

A scanner unit 14 is provided in an upper portion of image forming apparatus 10 and covered with a cover 15 in an openable manner. As shown in FIG. 2, first outer surface 10D of image forming apparatus 10 includes a first opposing region 10D1 and a first coupling region 10D2 located on a side of image forming apparatus 10 where first opposing region 10D1 is formed.

(Server Apparatus 20)

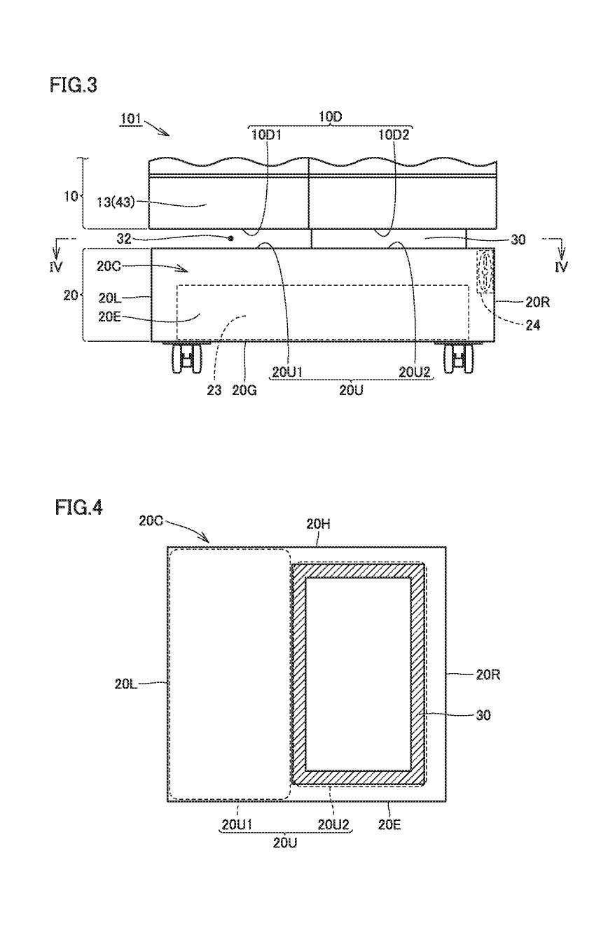

FIG. 3 is a front view showing server apparatus 20 and coupling portion 30, and shows information processing equipment 101 in FIG. 1 from which covers 21 and 22 have been removed in a direction shown with an arrow III in FIG. 1. FIG. 4 is a cross-sectional view along the line IV-IV in FIG. 3. FIG. 5 is a perspective view showing server apparatus 20 (with covers 21 and 22 having been removed) and coupling portion 30.

Server apparatus 20 is connected to image forming apparatus 10 through a not-shown signal line and exchanges as necessary a sensor value from each apparatus or data used for operation of the apparatus. Image forming apparatus 10 and server apparatus 20 have power supplies separate from each other and can operate independently of each other, and server apparatus 20 is basically characterized by constantly operating in order to be accessed by client apparatuses through a network.

Server apparatus 20 alone can function as a mail server, a web server, an application server, a file server, or a print server, and can perform processing in response to a request from a client apparatus based on a predetermined computer program (for example, storage of data, organization of data, various types of dynamic processing, and various types of response processing).

An outer geometry of server apparatus 20 is also substantially in a form of a parallelepiped as a whole (FIG. 1 and FIG. 5), and server apparatus 20 has a front surface 20F, a back surface 20B, a right side surface 20R, a left side surface 20L, a second outer surface 20U (see FIG. 2 and FIG. 3), and a bottom surface 20D. Second outer surface 20U is an outer surface of a housing of server apparatus 20 opposed to image forming apparatus 10 and it corresponds to an upper surface of server apparatus 20 in the present embodiment.

As shown in FIG. 2 to FIG. 4, server apparatus 20 (FIG. 3) includes as its constituent elements, a housing 20C, a server main body portion 23 (FIG. 2 and FIG. 3), a fan 24, and covers 21 and 22 (FIG. 1). Server main body portion 23 is constituted of a mother board, a CPU, a recording apparatus (such as an HDD or an SSD), a network interface (IF), a heat sink, and a power supply.

Housing 20C is formed in a shape of a box and server main body portion 23 and fan 24 are provided inside housing 20C. Power from a commercial power supply is supplied to various types of equipment constituting server main body portion 23 and fan 24. Air inlets 20H1 and 20H2 (FIG. 2) are provided in housing 20C and an air flow generated by fan 24 is taken into housing 20C through air inlet 20H1 to cool various types of equipment constituting server main body portion 23 and thereafter exhausted to the outside of server apparatus 20 through air inlet 20H2 (FIG. 2).

Covers 21 and 22 are substantially in a U shape in a side view (FIG. 1) and provided to cover a front surface 20E (FIG. 3 to FIG. 5), a bottom surface 20G (FIG. 3), and a back surface 20H (FIG. 4 and FIG. 5) of housing 20C. For the sake of convenience of illustration, FIG. 3 to FIG. 5 show information processing equipment 101 (server apparatus 20) from which covers 21 and 22 have been removed.

A portion of covers 21 and 22 located on the front side (a portion of covers 21 and 22 which covers front surface 20E of housing 20C) defines front surface 20F (FIG. 1) of server apparatus 20, a portion of covers 21 and 22 located on the back side (a portion of covers 21 and 22 which covers back surface 20H of housing 20C) defines back surface 20B (FIG. 1) of server apparatus 20, and a portion of covers 21 and 22 located on a side of the bottom surface (a portion of covers 21 and 22 which covers bottom surface 20G of housing 20C) defines bottom surface 20D (FIG. 1) of server apparatus 20.

As shown in FIG. 2 to FIG. 5, second outer surface 20U of server apparatus 20 (housing 20C) includes a second opposing region 20U1 and a second coupling region 20U2 located on a side of server apparatus 20 where second opposing region 20U1 is formed. Second opposing region 20U1 is opposed to first opposing region 10D1 of image forming apparatus 10 at a distance therefrom (with an air passage space portion 32 which will be described later being interposed).

Referring again to FIG. 1, in image forming apparatus 10 and server apparatus 20 constructed as set forth above, front surfaces 10F and 20F define a front surface of information processing equipment 101. Back surfaces 10B and 20B define a back surface of information processing equipment 101. Right side surfaces 10R and 20R define a right side surface of information processing equipment 101. Left side surfaces 10L and 20L define a left side surface of information processing equipment 101. Upper surface 10U defines an upper surface of information processing equipment 101. Bottom surface 20D defines a bottom surface of information processing equipment 101.

(Coupling Portion 30 and Air Passage Space Portion 32)

As shown in FIG. 2 to FIG. 5, coupling portion 30 integrates image forming apparatus 10 and server apparatus 20 with each other by coupling first coupling region 10D2 of image forming apparatus 10 located on first outer surface 10D and second coupling region 20U2 of server apparatus 20 located on second outer surface 20U to each other.

Image forming apparatus 10 is arranged above server apparatus 20 in the present embodiment. Coupling portion 30 has a prescribed height (a height corresponding to air passage space portion 32) and a plurality of pins 35 (FIG. 5) for positioning are provided on an upper surface of coupling portion 30. In first coupling region 10D2 of image forming apparatus 10, a plurality of insertion holes (not shown) are provided at positions corresponding to the plurality of pins 35. Image forming apparatus 10 is placed on coupling portion 30 by inserting pins 35 into the insertion holes and image forming apparatus 10 is fixed to coupling portion 30 and/or server apparatus 20 by such fastening means as a not-shown bolt.

Referring to FIG. 2 and FIG. 3, air passage space portion 32 through which outside air can pass is provided between first opposing region 10D1 on first outer surface 10D other than first coupling region 10D2 and second opposing region 20U1 on second outer surface 20U other than second coupling region 20U2.

(Function and Effect)

By providing air passage space portion 32 between first opposing region 10D1 and second opposing region 20U1, air passage space portion 32 can function as a heat insulating space which suppresses heat conduction. Therefore, conduction of heat generated in server apparatus 20 to image forming apparatus 10 or conduction of heat generated in image forming apparatus 10 to server apparatus 20 can be suppressed. Since air passage space portion 32 is further constructed to allow outside air to pass therethrough, heat from image forming apparatus 10 or server apparatus 20 can be exhausted to the outside without staying in air passage space portion 32. Therefore, such heat can efficiently be exhausted from image forming apparatus 10 and server apparatus 20 to the outside of information processing equipment 101.

Since image forming apparatus 10 is arranged above server apparatus 20 in the present embodiment, high design quality and high functionality (for example, space saving) as information processing equipment 101 can be realized. Furthermore, paper carrying portion 43 is arranged above first opposing region 10D1 and heater 43H for dehumidifying recording paper is provided in paper carrying portion 43. Most of heat generated by heater 43H can be exhausted to the outside of information processing equipment 101 through first opposing region 10D1 and air passage space portion 32, and the heat hardly conducts to server apparatus 20.

In the present embodiment, air passage space portion 32 is in such a shape as extending to pass through (linearly here) from a side of a surface (a side of the front surface (front surfaces 10F and 20F) as a third outer surface) formed on one side of information processing equipment 101 with first outer surface 10D being interposed toward a surface (a side of the back surface (back surfaces 10B and 20B) as a fourth outer surface) formed on the other side opposite to the one side in information processing equipment 101. In other words, when information processing equipment 101 (air passage space portion 32) is viewed from the front as shown in FIG. 3, a rear side can visually be recognized from the front through air passage space portion 32. Though such a construction is not essential, when air passage space portion 32 provided to extend across the apparatus from the front side toward the back side of information processing equipment 101 is adopted, there is no component in air passage space portion 32 that blocks an air flow and hence the air flow can smoothly flow through the inside of air passage space portion 32 and high heat radiation characteristics and a heat shielding effect can be obtained. Air passage space portion 32 in such a shape is also advantageous in that an air passage flow path can be secured even though information processing equipment 101 is installed in proximity to a wall surface. Though a side of left side surfaces 10L and 20L of air passage space portion 32 is open in the present embodiment, air passage space portion 32 may be in a shape of a tunnel (through hole).

As shown in FIG. 4, in the present embodiment, an approximately half region located on a side of left side surface 20L of second outer surface 20U of housing 20C constituting server apparatus 20 forms second opposing region 20U1, an approximately half region located on a side of right side surface 20R forms second coupling region 20U2, and coupling portion 30 couples first coupling region 10D2 of image forming apparatus 10 and second coupling region 20U2 of server apparatus 20 to each other.

In order to realize a stable structure for holding image forming apparatus 10 by coupling portion 30 in a suitable form, coupling portion 30 is preferably arranged below a position of the center of gravity of image forming apparatus 10. Referring to FIG. 2, a position of the center of gravity of image forming apparatus 10 can be set, for example, in the vicinity of support roller 58 of image forming apparatus 10. Alternatively, coupling portion 30 may be arranged below fixing portion 62 (FIG. 2) provided inside image forming apparatus 10.

Alternatively, coupling portion 30 may be arranged below a portion which extends upward from below in the paper transportation path provided inside image forming apparatus 10. The portion of the paper transportation path which extends upward from below refers to a portion of the paper transportation path defined by timing roller 41R, secondary transfer portion 61, and fixing portion 62 in the present embodiment. Coupling portion 30 may be arranged below secondary transfer portion 61 provided inside image forming apparatus 10 without being limited to the construction as above.

Balance in weight of the image forming apparatus is generally uneven toward a side where relatively heavy equipment such as fixing portion 62 is arranged (a side where the paper transportation path extending upward from below is located) with respect to a central position in a horizontal direction of the apparatus. Nevertheless, even when image forming apparatus 10 is arranged above server apparatus 20, by arranging coupling portion 30 as above in accordance with a portion where the weight of image forming apparatus 10 is concentrated, a stable structure for holding image forming apparatus 10 by coupling portion 30 can be realized with a small cross-sectional area.

Technical meaning of arrangement of coupling portion 30 below a specific portion in the description is that a projected image virtually formed when the specific portion is projected downward in a direction of gravity is at least partially superimposed on coupling portion 30 (a portion of coupling between image forming apparatus 10 and server apparatus 20). It is not essential to arrange image forming apparatus 10 above server apparatus 20, and server apparatus 20 can be arranged at any position such as a side surface side or a back surface side of image forming apparatus 10 so long as the position is around image forming apparatus 10 where coupling by coupling portion 30 can be made. When scanner unit 14 is not provided in the upper portion of image forming apparatus 10, server apparatus 20 can also readily be arranged above image forming apparatus 10.

### Second Embodiment

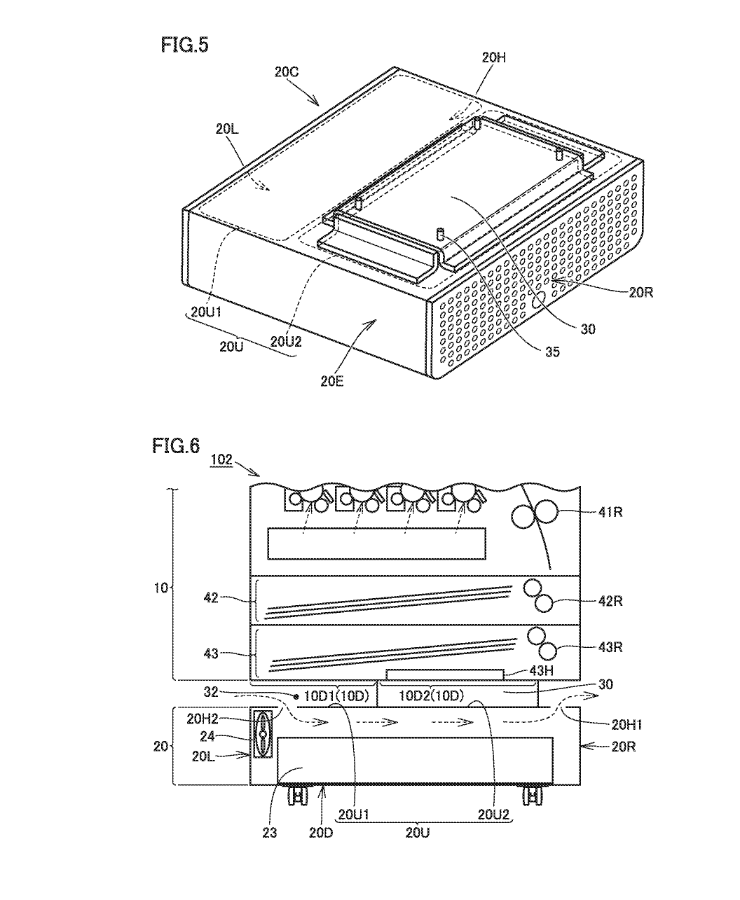

FIG. 6 is a cross-sectional view schematically showing server apparatus 20 and coupling portion 30 included in information processing equipment 102 in a second embodiment when viewed from the front, and corresponds to FIG. 2 in the first embodiment. Information processing equipment 101 in the first embodiment and information processing equipment 102 in the second embodiment are different from each other in the following points.

In information processing equipment 102, air inlet 20H2 which allows communication between the inside and the outside of server apparatus 20 is provided in second opposing region 20U1 of server apparatus 20. In order to prevent introduction of dust, a filter (not shown) which covers air inlet 20H2 may be provided to lie over air inlet 20H2. Air inlet 20H1 is also provided in second outer surface 20U of server apparatus 20. According to the construction, not only the heat radiation characteristics and the heat shielding effect of air passage space portion 32 are improved but also it is difficult for an observer to visually recognize air inlet 20H1 and air inlet 20H2 when information processing equipment 102 as a whole is observed and hence design quality can be improved. Though air inlet 20H2 functions as an introduction port and air inlet 20H1 functions as an emission port, air inlet 20H2 may function as an emission port and air inlet 20H1 may function as an introduction port.

### Third Embodiment

FIG. 7 is a cross-sectional view schematically showing server apparatus 20 and coupling portion 30 included in information processing equipment 103 in a third embodiment when viewed from the front, and corresponds to FIG. 2 in the first embodiment. Information processing equipment 101 in the first embodiment and information processing equipment 103 in the third embodiment are different from each other in the following points.

In information processing equipment 103, a member which forms second opposing region 20U1 of the housing (see housing 20C shown in FIG. 5) which forms server apparatus 20 is higher in thermal conductivity than a member which forms a portion of the housing different from second opposing region 20U1 (for example, second coupling region 20U2, front surface 20E, or back surface 20H). Such a construction may be achieved by selection of a material (for example, copper or aluminum) for the member which forms second opposing region 20U1 or a material (for example, iron) for a member which forms a portion different from second opposing region 20U1 or by a structural feature (for example, providing a plurality of heat radiation fins) of a member which forms second opposing region 20U1.

With improvement in thermal conductivity of the portion which forms second opposing region 20U1 of the housing (see housing 20C shown in FIG. 5) which forms server apparatus 20, heat radiation characteristics as server apparatus 20 as a whole can be improved while air passage space portion 32 is made use of

### Fourth Embodiment

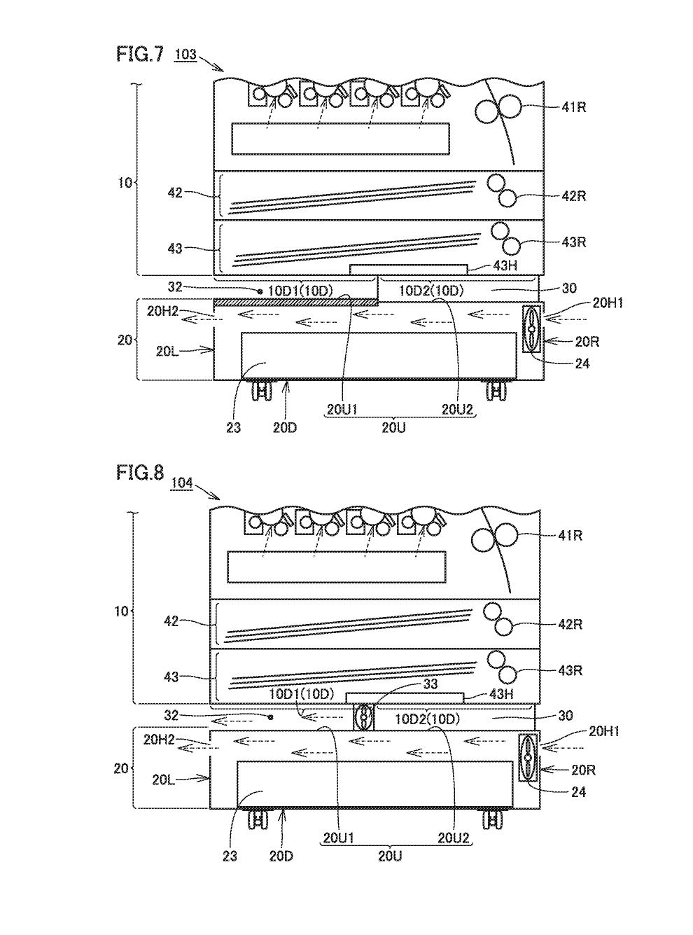

FIG. 8 is a cross-sectional view schematically showing server apparatus 20 and coupling portion 30 included in information processing equipment 104 in a fourth embodiment when viewed from the front, and corresponds to FIG. 2 in the first embodiment. Information processing equipment 101 in the first embodiment and information processing equipment 104 in the fourth embodiment are different from each other in the following points.

Information processing equipment 104 further includes a fan 33 which generates an air flow which flows through the inside of air passage space portion 32. With fan 33, heat radiation characteristics or heat shielding efficiency in first opposing region 10D1 and second opposing region 20U1 can be improved. Arrangement of fan 33 inside air passage space portion 32 (for example, at a position adjacent to coupling portion 30) can also suitably be adopted from a point of view of inconspicuousness of fan 33.

Although embodiments of the present invention have been described and illustrated in detail, the disclosed embodiments are made for purposes of illustration and example only and not limitation. The scope of the present invention should be interpreted by terms of the appended claims.

What is claimed is:

1. Information processing equipment comprising:
an image forming apparatus which has a first outer surface, the image forming apparatus forming an image on a recording medium; and
a server apparatus which has a second outer surface opposed to the first outer surface at a distance from the first outer surface, the server apparatus being connected to a network and performing predetermined processing,
the information processing equipment having
a coupling portion which integrates the image forming apparatus and the server apparatus with each other by coupling a first coupling region located on the first outer surface of the image forming apparatus and a second coupling region located on the second outer surface of the server apparatus to each other, and
an air passage space portion through which outside air can pass, the air passage space portion being provided between a first opposing region on the first outer surface other than the first coupling region and a second opposing region on the second outer surface other than the second coupling region.

2. The information processing equipment according to claim 1, wherein
the air passage space portion is in such a shape as extending to pass through from a third outer surface formed on one side of the information processing equipment toward a fourth outer surface formed on the other side opposite to the one side of the information processing equipment with the first outer surface being interposed therebetween.

3. The information processing equipment according to claim 1, wherein
the image forming apparatus is arranged above the server apparatus.

4. The information processing equipment according to claim 3, wherein
the coupling portion is arranged below a position of a center of gravity of the image forming apparatus.

5. The information processing equipment according to claim 3, wherein
the coupling portion is arranged below a fixing portion provided inside the image forming apparatus.

6. The information processing equipment according to claim 3, wherein
the coupling portion is arranged below a portion which extends upward from below in a paper transportation path provided inside the image forming apparatus.

7. The information processing equipment according to claim 3, wherein
the coupling portion is arranged below a secondary transfer portion provided inside the image forming apparatus.

8. The information processing equipment according to claim 3, wherein
the server apparatus includes a server main body portion and a housing where the server main body portion is arranged therein, and
a member of the housing which forms the second opposing region is higher in thermal conductivity than a member of the housing which forms a portion different from the second opposing region.

9. The information processing equipment according to claim 3, wherein
the second opposing region is provided with an air inlet which allows communication between inside and outside of the server apparatus.

10. The information processing equipment according to claim 3, the information processing equipment further comprising a fan which generates an air flow which flows through inside of the air passage space portion.

11. The information processing equipment according to claim 3, wherein
the image forming apparatus has a paper carrying portion arranged above the first opposing region.
